(19) United States
(12) Patent Application Publication
(10) Pub. No.: US 2009/0169736 A1
(43) Pub. Date: Jul. 2, 2009

(54) THERMOSETTING RESIN COMPOSITION, METHOD OF FORMING ANTIHALATION FILM OF SOLID-STATE IMAGING DEVICE, ANTIHALATION FILM FOR SOLID-STATE IMAGING DEVICES, AND SOLID-STATE IMAGING DEVICE

(75) Inventor: Junji Yoshizawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JSR CORPORATION, Chuo-ku (JP)

(21) Appl. No.: 12/304,644

(22) PCT Filed: Jun. 7, 2007
(86) PCT No.: PCT/JP07/61954

§ 371 Date: Dec. 12, 2008

(30) Foreign Application Priority Data
Jun. 13, 2006 (JP) 2006-163292

(51) Int. Cl. B05D 5/06; F21V 9/06

(52) U.S. Cl. 427/162; 252/589

(57) ABSTRACT

A thermosetting resin composition comprising a polymer having a methylglycidyl group and an ultraviolet absorbent. This thermosetting resin composition has excellent storage stability and forms an antihalation film which can effectively suppress diffused reflection light from a foundation substrate in an exposure step for forming a color filter or microlens in a solid-state imaging device, has high heat resistance and does not have a rough surface even when it is subjected to dry etching.

### TECHNICAL FIELD

The present invention relates to a thermosetting resin composition, a method of forming the antihalation film of a solid-state imaging device, an antihalation film for solid-state imaging devices, and a solid-state imaging device.

### BACKGROUND ART

Solid-state imaging devices are divided into MOS (Metal Oxide Semiconductor) and CCD (Charge Coupled Device) types both of which are further divided into one-dimensional solid-state imaging devices and two-dimensional solid-state imaging devices. An example of the former is a facsimile and an example of the latter is a video camera.

Demand for higher image quality is growing for solid-state imaging devices due to progress in digitization and users' preference for higher quality products. An increase in the number of pixels of a digital camera is such an example.

Solid-state imaging devices are available in black/white and color. Out of these, the color solid-state imaging devices are manufactured by forming three color filters on a substrate having solid-state imaging devices thereon. The solid-state imaging devices can be used directly but sensitivity (light condensing capability) is improved by forming convex lenses (microlenses) on the surface, corresponding to the number of the solid-state imaging devices (refer to JP-A 3-223702).

To provide color filters and/or microlenses to the solid-state imaging devices, lithography using a photosensitive material is used to form a fine pattern.

The formation of microlenses is carried out by applying a transparent resin to a substrate having solid-state imaging devices and optionally color filters to flatten its surface, applying a microlens material which is a photosensitive resin, exposing it to light to form a lens pattern, developing and rinsing it, and heating the remaining transparent resin blocks to slightly melt and shrink them so as to form each block into a convex lens.

When the photosensitive material is exposed and patterned in the above step of forming color filters or microlenses, a portion which should not be exposed is exposed to diffused reflection light from the foundation substrate with the result that the actual pattern size becomes different from the target size. That is, “halation” occurs.

In the case of microlenses, when this phenomenon occurs, the lenses become nonuniform in shape and a flicker occurs, thereby exerting a bad influence upon image quality. This is becoming more serious as the cell size of a solid-state imaging device is becoming smaller.

To solve this problem, there is known a method for preventing halation by forming an antireflection film which absorbs radiation used for lithography on a solid-state imaging device substrate to suppress reflection. As an example of this method, there is one in which a dye is blended into a CCD protective film comprising polyglycidyl methacrylate as the main component and trimellitic acid as a curing agent (refer to Japanese Patent No. 2956210). However, this antireflection film has such a disadvantage that part of the dye sublimes from the antireflection film in the baking step for crosslinking the applied material to solidify it, thereby greatly reducing the antihalation effect or that, when a nonvolatile dye is used, it oozes off onto a protective film and thereby microlenses to be formed on the antihalation film may not be formed into a desired shape.

There is proposed an antihalation film which comprises a copolymer of an unsaturated carboxylic acid and/or an unsaturated carboxylic anhydride, an epoxy group-containing radically polymerizable compound and a mono- and/or di-olefin-based unsaturated compound, and a radiation absorbing compound (refer to JP-A 06-289201). This antihalation film is based on the assumption that the temperature history after film formation is 150° C. or lower, and the heat resistance of the film at a temperature higher than 150° C. is not verified.

However, since a color filter material which comprises a dye matrix is used in a color solid-state imaging device, a color filter can be cured at a relatively low temperature, for example, around 150° C. However, as a pigment-based material is commonly used to meet demand for high-definition images, a curing temperature of 180° C. or higher is needed in the step of forming a color filter (refer to JP-A 11-211911, JP-A 11-258415 and JP-A 2000-111722).

Therefore, the antihalation film which is formed prior to the color filter in the color solid-state imaging device is exposed to a higher temperature than before. It is known that when the conventionally known antihalation film is exposed to such a high temperature, it does not function as an antihalation film any more. This phenomenon is assumed to be because the radiation absorbability of a radiation absorbent blended with the antihalation film material greatly degrades due to its sublimation and scattering at a temperature range higher than 150° C.

Most of the existing antihalation films are two-liquid antihalation films but one-liquid antihalation films are desired from the viewpoint of handling ease. Further, since even a one-liquid antihalation film becomes viscous at room temperature in almost one week, it becomes solid in the peripheral portion of an apparatus, thereby increasing the number of times of maintenance and reducing the yield. Therefore, an antihalation film which has excellent storage stability at room temperature is desired.

### DISCLOSURE OF THE INVENTION

It is an object of the present invention which has been made in view of the above situation to provide a thermosetting resin composition having excellent storage stability and suitable for forming an antihalation film which can effectively suppress diffused reflection light from a foundation substrate in an exposure step for forming a color filter or microlens in a solid-state imaging device, has high heat resistance and does not have a rough surface even when it is subjected to dry etching, a method of forming an antihalation film from the thermosetting resin composition, an antihalation film formed by the method, and a solid-state imaging device having the antihalation film.

According to the present invention, firstly, the above object is attained by a thermosetting resin composition comprising [A] a polymer having a methylglycidyl group and [B] an ultraviolet absorbent. The above component [A] is preferably a copolymer of (a1) a polymerizable unsaturated compound having a methylglycidyl group and (a2) a polymerizable unsaturated compound other than the above component (a1).

Secondly, the above object of the present invention is attained by a method of forming the antihalation film of a solid-state imaging device, comprising at least the following steps:

[1] forming a coating film of the above thermosetting resin composition on a substrate; and

[2] heating the coating film.

Thirdly, the above object of the present invention is attained by an antihalation film for solid-state imaging devices formed by the above method. In the fourth place, the above object is attained by a solid-state imaging device having the above antihalation film.

### BRIEF DESCRIPTION OF THE DRAWINGS

FIG. 1(a) and FIG. 1(b) are diagrams of the shapes of the side faces of microlens patterns.

### BEST MODE FOR CARRYING OUT THE INVENTION

Each of the components of the thermosetting resin composition of the present invention will be described in detail hereinunder.

### [A] Polymer

The polymer as the component [A] in the present invention is a homopolymer or polymer having a methylglycidyl group, preferably a copolymer of (a1) a polymerizable unsaturated compound having a methylglycidyl group and (a2) a polymerizable unsaturated compound different from the above component (a1).

Since the component [A] has a recurring unit derived from (a1) a polymerizable unsaturated compound having a methylglycidyl group, it serves to satisfy the requirements for hardness and excellent storage stability which are the essential properties of a permanent film in the thermosetting resin composition of the present invention.

The polymerizable unsaturated compound (a1) has a methylglycidyl group and a polymerizable unsaturated group. Examples of the polymerizable unsaturated compound (a1) include methyl glycidyl acrylate (alias: acrylic acid 2-methyl-oxiranylmethyl ester), methyl glycidyl methacrylate (alias: 2-methyl-acrylic acid 2-methyl-oxiranylmethyl ester), 2-methyl-2-(4-vinyl-phenoxymethyl)-oxirane and 2-methyl-acrylic acid 2-(2-methyl-2-methyl-oxiranylmethoxy)-ethyl ester.

Out of these, methyl glycidyl methacrylate (alias: 2-methyl-acrylic acid 2-methyl-oxiranylmethyl ester) is preferred from the viewpoint of improving copolymerization reactivity and the heat resistance and surface hardness of the obtained film.

The components (a1) may be used alone or in combination of two or more.

The polymerizable unsaturated compound (a2) is a polymerizable unsaturated compound different from the above component (a1), and examples thereof include polymerizable unsaturated carboxylic acids, polymerizable unsaturated polycarboxylic anhydrides, polymerizable unsaturated compounds having at least one structure selected from the group consisting of an acetal structure, ketal structure and tertiary carbon alkoxycarbonyl structure, and polymerizable unsaturated compounds having none of the carboxylic acid group, the carboxylic anhydride group and the above structures.

The polymerizable unsaturated compound (a2) is preferably a polymerizable unsaturated carboxylic acid and/or a polymerizable unsaturated polycarboxylic anhydride.

The polymerizable unsaturated compounds (a2) may be used alone or in combination of two or more.

Examples of the polymer [A] which is preferred in the present invention include:

(A1) a copolymer (to be referred to as “copolymer (A1)” hereinafter) of (a1) a polymerizable unsaturated compound (to be referred to as “unsaturated compound (a1)” hereinafter), (a2) a polymerizable unsaturated carboxylic acid and/or a polymerizable unsaturated polycarboxylic anhydride (to be referred to as “unsaturated compound (a2-1)” hereinafter) and (a2) a polymerizable unsaturated compound different from the unsaturated compound (a1) and the unsaturated compound (a2-1) (to be referred to as “unsaturated compound (a2-2)” hereinafter);

(A2) a copolymer (to be referred to as “copolymer (A2)” hereinafter) of the unsaturated compound (a1), (a2) a polymerizable unsaturated compound having at least one structure selected from the group consisting of an acetal structure, ketal structure and t-butoxycarbonyl structure (to be referred to as “unsaturated compound (a2-3)” hereinafter), and (a2) a polymerizable unsaturated compound different from the unsaturated compound (a1) and the unsaturated compound (a2-3) (to be referred to as “unsaturated compound (a2-4)” hereinafter); and

(A3) a copolymer (to be referred to as “copolymer (A3)” hereinafter) of the unsaturated compound (a1) and (a2) a polymerizable unsaturated compound different from the unsaturated compound (a1) (to be referred to as “unsaturated compound (a2-5)” hereinafter), the copolymer having none of a carboxyl group, carboxylic anhydride group, acetal structure, ketal structure and t-butoxycarbonyl structure in the molecule.

The copolymer (A1) may further contain an acetal structure, ketal structure or t-butoxycarbonyl structure, and the copolymer (A2) may further contain a carboxyl group or carboxylic anhydride group.

In the copolymer (A1), the copolymer (A2) and the copolymer (A3), the above compounds can be enumerated as examples of the unsaturated compound (a1).

The above unsaturated compounds (a1) may be used alone or in combination of two or more.

Examples of the unsaturated compound (a2-1) in the copolymer (A1) include unsaturated carboxylic acids such as (meth)acrylic acid, crotonic acid, α-ethylacrylic acid, α-n-propylacrylic acid, α-n-butylacrylic acid, maleic acid, fumaric acid, citraconic acid, mesaconic acid and itaconic acid; and unsaturated polycarboxylic anhydrides such as maleic anhydride, itaconic anhydride, citraconic anhydride and cis-1,2,3,4-tetrahydrophthalic anhydride.

Out of these unsaturated compounds (a2-1), acrylic acid and methacrylic acid are particularly preferred as the unsaturated carboxylic acid, and maleic anhydride is particularly preferred as the unsaturated polycarboxylic anhydride. These preferred unsaturated compounds (a2-1) have high copolymerization reactivity and are effective in enhancing the heat resistance and surface hardness of the obtained film.

The above unsaturated compounds (a2-1) may be used alone or in combination of two or more.

Examples of the unsaturated compound (a2-2) include hydroxyalkyl (meth)acrylates such as 2-hydroxyethyl (meth)acrylate and 2-hydroxypropyl (meth)acrylate; alkyl (meth)acrylates such as methyl (meth)acrylate, ethyl (meth)acrylate, n-propyl (meth)acrylate, i-propyl (meth)acrylate, n-butyl (meth)acrylate, i-butyl (meth)acrylate, sec-butyl (meth)acrylate and t-butyl (meth)acrylate; alicyclic (meth)acrylates such as cyclopentyl (meth)acrylate, cyclohexyl (meth)acrylate, 2-methylcyclohexyl (meth)acrylate, tricyclo[5.2.1.0^{2,6}]decan-8-yl (meth)acrylate (tricyclo[5.2.1.0^{2,6}]decan-8-yl will be referred to as “dicyclopentanyl” hereinafter), 2-dicyclopentanyloxyethyl (meth)acrylate and isobornyl (meth)acrylate; aryl (meth)acrylates such as phenyl (meth)acrylate and benzyl (meth)acrylate; unsaturated dicarboxylic acid diesters such as diethyl maleate, diethyl fumarate and diethyl itaconate; unsaturated dicarbonylimides such as N-phenylmaleimide, N-benzylmaleimide, N-cyclohexylmaleimide, N-succinimidyl-3-maleimide benzoate, N-succinimidyl-4-maleimide butyrate, N-succinimidyl-6-maleimide caproate, N-succinimidyl-3-maleimide propionate and N-(9-acridinyl)maleimide; vinyl cyanide compounds such as (meth)acrylonitrile, α-chloroacrylonitrile and vinylidene cyanide; unsaturated amide compounds such as (meth)acrylamide and N,N-dimethyl (meth)acrylamide; aromatic vinyl compounds such as styrene, α-methylstyrene, m-methylstyrene, p-methylstyrene, vinyl toluene and p-methoxystyrene; indenes such as indene and 1-methylindene; conjugated diene compounds such as 1,3-butadiene, isoprene and 2,3-dimethyl-1,3-butadiene; and vinyl chloride, vinylidene chloride and vinyl acetate.

Out of these unsaturated compounds (a2-2), methyl methacrylate, t-butyl methacrylate, cyclohexyl acrylate, dicyclopentanyl methacrylate, 2-methylcyclohexyl acrylate, N-phenylmaleimide, N-cyclohexylmaleimide, styrene, p-methoxystyrene and 1,3-butadiene are preferred. These preferred unsaturated compounds (a2-2) have high copolymerization reactivity and are effective in enhancing the heat resistance and surface hardness of the obtained film, except 1,3-butadiene.

The above unsaturated compounds (a2-2) may be used alone or in combination of two or more.

Preferred examples of the copolymer (A1) include a copolymer of methyl glycidyl acrylate, acrylic acid, tricyclo[5.2.1.0^{2,6}]decan-8-yl acrylate and styrene, copolymer of methyl glycidyl methacrylate, methacrylic acid, tricyclo[5.2.1.0^{2,6}]decan-8-yl methacrylate and styrene, copolymer of methyl glycidyl methacrylate, methacrylic acid, methyl methacrylate and styrene, copolymer of methyl glycidyl methacrylate, methacrylic acid, cyclohexyl acrylate and p-methoxystyrene, copolymer of methyl glycidyl acrylate, acrylic acid, N-phenylmaleimide and styrene, copolymer of methyl glycidyl methacrylate, methacrylic acid, N-phenylmaleimide and styrene, copolymer of methyl glycidyl methacrylate, methacrylic acid, N-cyclohexylmaleimide and styrene, and copolymer of methyl glycidyl methacrylate, methacrylic acid, tricyclo[5.2.1.0^{2,6}]decan-8-yl methacrylate and 1,3-butadiene.

Out of these copolymers (A1), more preferred are a copolymer of methyl glycidyl methacrylate, methacrylic acid, tricyclo[5.2.1.0^{2,6}]decan-8-yl methacrylate and styrene, copolymer of methyl glycidyl methacrylate, methacrylic acid, N-phenylmaleimide and styrene, copolymer of methyl glycidyl methacrylate, methacrylic acid, N-cyclohexylmaleimide and styrene, copolymer of methyl glycidyl methacrylate, methacrylic acid, tricyclo[5.2.1.0^{2,6}]decan-8-yl methacrylate and 1,3-butadiene, and copolymer of methyl glycidyl methacrylate, methacrylic acid, tricyclo[5.2.1.0^{2,6}]decan-8-yl methacrylate, styrene and 1,3-butadiene.

In the copolymer (A1), the content of the recurring unit derived from the unsaturated compound (a1) is preferably 10 to 70 wt %, particularly preferably 20 to 60 wt % based on the total of all the recurring units. The total content of the recurring units derived from the polymerizable unsaturated carboxylic acid and the polymerizable unsaturated polycarboxylic anhydride is preferably 5 to 40 wt %, particularly preferably 10 to 30 wt % based on the total of all the recurring units. The content of the recurring unit derived from the other polymerizable unsaturated compound is preferably 10 to 70 wt %, particularly preferably 20 to 50 wt % based on the total of all the recurring units.

When the content of the recurring unit derived from the unsaturated compound (a1) is lower than 10 wt %, the heat resistance and surface hardness of the protective film may lower and when the content is higher than 70 wt %, the storage stability of the composition may degrade. When the total content of the recurring units derived from the polymerizable unsaturated carboxylic acid and the polymerizable unsaturated polycarboxylic anhydride is lower than 5 wt %, the heat resistance, surface hardness and chemical resistance of the film may lower and when the total content is higher than 40 wt %, the storage stability of the composition may degrade. When the content of the recurring unit derived from the other polymerizable unsaturated compound is lower than 10 wt %, the storage stability of the composition may degrade and when the content is higher than 70 wt %, the heat resistance and surface hardness of the film may lower.

In the copolymer (A2), the unsaturated compound (a2-3) is selected from a norbornene-based compound having at least one structure selected from the group consisting of acetal structure, ketal structure and t-butoxycarbonyl structure (to be referred to as “specific norbornene-based compound” hereinafter), a (meth)acrylate compound having an acetal structure and/or a ketal structure (to be referred to as “specific (meth)acrylate compound” hereinafter) and t-butyl (meth)acrylate.

Examples of the specific norbornene-based compound include 2,3-di(1-methoxyethoxycarbonyl)-5-norbornene, 2,3-di(1-t-butoxyethoxycarbonyl)-5-norbornene, 2,3-di(1-benzyloxyethoxycarbonyl)-5-norbornene, 2,3-di(1-methyl-1-methoxyethoxycarbonyl)-5-norbornene, 2,3-di(1-methyl-1-i-butoxyethoxycarbonyl)-5-norbornene, 2,3-di[(cyclohexyl)(ethoxy)methoxycarbonyl)-5-norbornene, 2,3-di[(benzyl)(ethoxy)methoxycarbonyl)-5-norbornene, 2,3-di(tetrahydrofuran-2-yloxycarbonyl)-5-norbornene, 2,3-di(tetrahydropyran-2-yloxycarbonyl)-5-norbornene and 2,3-di(t-butoxycarbonyl)-5-norbornene.

Examples of the specific (meth)acrylate compound include 1-ethoxyethyl (meth)acrylate, 1-n-propoxyethyl (meth)acrylate, 1-n-butoxyethyl (meth)acrylate, 1-i-butoxyethyl (meth)acrylate, 1-(cyclopentyloxy)ethyl (meth)acrylate, 1-(cyclohexyloxy)ethyl (meth)acrylate, 1-(1,1-dimethylethoxy)ethyl (meth)acrylate and tetrahydro-2H-pyran-2-yl (meth)acrylate.

Out of these unsaturated compounds (a2-3), the specific (meth)acrylate compounds are preferred, and 1-ethoxyethyl methacrylate, 1-i-butoxyethyl methacrylate, 1-(cyclopentyloxy)ethyl methacrylate, 1-(cyclohexyloxy)ethyl methacrylate, 1-(1,1-dimethylthoxy)ethyl methacrylate, tetrahydro-2H-pyran-2-yl methacrylate and t-butyl methacrylate are particularly preferred. These preferred unsaturated compounds (a2-3) have high copolymerization reactivity, provide a one-liquid type curable resin composition having excellent storage stability and film flatness, and are effective in enhancing the heat resistance and surface hardness of the obtained film.

The above unsaturated compounds (a2-3) may be used alone or in combination of two or more.

Examples of the unsaturated compound (a2-4) are the same as compounds listed for the above unsaturated compound (a2-1) and the above unsaturated compound (a2-2).

Out of these unsaturated compounds (a2-4), methyl methacrylate, cyclohexyl acrylate, tricyclo[5.2.1.0^{2,6}]decan-8-yl methacrylate, 2-methylcyclohexyl acrylate, N-phenylmaleimide, N-cyclohexylmaleimide, styrene, p-methoxystyrene and 1,3-butadiene are particularly preferred. These preferred unsaturated compounds (a2-4) have high copolymerization reactivity and are effective in enhancing the heat resistance and surface hardness of the obtained film, except 1,3-butadiene.

The above unsaturated compounds (a2-4) may be used alone or in combination of two or more.

Preferred examples of the copolymer (A2) include a copolymer of methyl glycidyl methacrylate, tetrahydro-2H-pyran-2-yl acrylate, tricyclo[5.2.1.0^{2,6}]decan-8-yl methacrylate and styrene, copolymer of methyl glycidyl methacrylate, tetrahydro-2H-pyran-2-yl methacrylate, tricyclo[5.2.1.0^{2,6}]decan-8-yl methacrylate and styrene, copolymer of methyl glycidyl methacrylate, tetrahydro-2H-pyran-2-yl acrylate, N-phenylmaleimide and styrene, copolymer of methyl glycidyl methacrylate, tetrahydro-2H-pyran-2-yl methacrylate, N-phenylmaleimide and styrene, copolymer of methyl glycidyl methacrylate, tetrahydro-2H-pyran-2-yl acrylate, N-cyclohexylmaleimide and styrene, copolymer of methyl glycidyl methacrylate, tetrahydro-2H-pyran-2-yl methacrylate, N-cyclohexylmaleimide and styrene, copolymer of methyl glycidyl methacrylate, 1-(cyclohexyloxy)ethyl acrylate, tricyclo[5.2.1.0^{2,6}]decan-8-yl methacrylate and styrene, copolymer of methyl glycidyl methacrylate, 1-(cyclohexyloxy)ethyl methacrylate, tricyclo[5.2.1.0^{2,6}]decan-8-yl methacrylate and styrene, copolymer of methyl glycidyl methacrylate, 1-(cyclohexyloxy)ethyl acrylate, N-cyclohexylmaleimide and styrene, copolymer of methyl glycidyl methacrylate, 1-(cyclohexyloxy)ethyl methacrylate, N-cyclohexylmaleimide and styrene, copolymer of methyl glycidyl methacrylate, 2,3-di(tetrahydropyran-2-yloxycarbonyl)-5-norbornene, tricyclo[5.2.1.0^{2,6}]decan-8-yl methacrylate and styrene, copolymer of methyl glycidyl methacrylate, 2,3-di(tetrahydropyran-2-yloxycarbonyl)-5-norbornene, N-cyclohexylmaleimide and styrene, copolymer of methyl glycidyl methacrylate, tetrahydro-2H-pyran-2-yl acrylate, tricyclo[5.2.1.0^{2,6}]decan-8-yl methacrylate and 1,3-butadiene, copolymer of methyl glycidyl methacrylate, tetrahydro-2H-pyran-2-yl methacrylate, tricyclo[5.2.1.0^{2,6}]decan-8-yl methacrylate and 1,3-butadiene, copolymer of methyl glycidyl methacrylate, tetrahydro-2H-pyran-2-yl acrylate, methyl methacrylate and styrene, copolymer of methyl glycidyl methacrylate, tetrahydro-2H-pyran-2-yl methacrylate, methyl methacrylate and styrene, copolymer of methyl glycidyl methacrylate, tetrahydro-2H-pyran-2-yl acrylate, cyclohexyl acrylate and p-methoxystyrene, copolymer of methyl glycidyl methacrylate, tetrahydro-2H-pyran-2-yl methacrylate, cyclohexyl acrylate and p-methoxystyrene, copolymer of methyl glycidyl acrylate, t-butyl methacrylate, N-phenylmaleimide and styrene, copolymer of methyl glycidyl methacrylate, t-butyl methacrylate, N-cyclohexylmaleimide and styrene, copolymer of methyl glycidyl methacrylate, 1-(cyclohexyloxy)ethyl acrylate, tricyclo[5.2.1.0^{2,6}]decan-8-yl methacrylate, styrene and 1,3-butadiene, and copolymer of methyl glycidyl methacrylate, 1-(cyclohexyloxy)ethyl methacrylate, tricyclo[5.2.1.0^{2,6}]decan-8-yl methacrylate, styrene and 1,3-butadiene.

Out of these copolymers (A2), more preferred are a copolymer of methyl glycidyl methacrylate, tetrahydro-2H-pyran-2-yl acrylate, tricyclo[5.2.1.0^{2,6}] decan-8-yl methacrylate and styrene, copolymer of methyl glycidyl methacrylate, tetrahydro-2H-pyran-2-yl methacrylate, tricyclo[5.2.1.0^{2,6}]decan-8-yl methacrylate and styrene, copolymer of methyl glycidyl methacrylate, tetrahydro-2H-pyran-2-yl acrylate, N-phenylmaleimide and styrene, copolymer of methyl glycidyl methacrylate, tetrahydro-2H-pyran-2-yl methacrylate, N-phenylmaleimide and styrene, copolymer of methyl glycidyl methacrylate, tetrahydro-2H-pyran-2-yl acrylate, N-cyclohexylmaleimide and styrene, copolymer of methyl glycidyl methacrylate, tetrahydro-2H-pyran-2-yl methacrylate, N-cyclohexylmaleimide and styrene, copolymer of methyl glycidyl methacrylate, 1-(cyclohexyloxy)ethyl acrylate, N-cyclohexylmaleimide and styrene, copolymer of methyl glycidyl methacrylate, 1-(cyclohexyloxy)ethyl methacrylate, N-cyclohexylmaleimide and styrene, copolymer of methyl glycidyl methacrylate, 2,3-di(tetrahydropyran-2-yloxycarbonyl)-5-norbornene, tricyclo[5.2.1.0^{2,6}]decan-8-yl methacrylate and styrene, copolymer of methyl glycidyl methacrylate, 2,3-di(tetrahydropyran-2-yloxycarbonyl)-5-norbornene, N-cyclohexylmaleimide and styrene, and copolymer of methyl glycidyl methacrylate, t-butyl methacrylate, N-cyclohexylmaleimide and styrene.

In the copolymer (A2), the content of the recurring unit derived from the unsaturated compound (a1) is preferably 10 to 70 wt %, particularly preferably 20 to 60 wt % based on the total of all the recurring units. When the content of the recurring unit derived from the unsaturated compound (a1) is lower than 10 wt %, the heat resistance and surface hardness of the film may lower and when the content is higher than 70 wt %, the storage stability of the composition may degrade.

The content of the recurring unit derived from the unsaturated compound (a2-3) is preferably 5 to 60 wt %, particularly preferably 10 to 50 wt %. When the content of the recurring unit derived from the unsaturated compound (a2-3) falls within this range, the heat resistance and surface hardness of the protective film become excellent.

The content of the recurring unit derived from the unsaturated compound (a2-4) is obtained by subtracting the total content of the recurring units derived from the unsaturated compound (a1) and the unsaturated compound (a2-3) from 100 wt %. When an unsaturated carboxylic acid or an unsaturated polycarboxylic anhydride is used as the unsaturated compound (a2-4), if the total content of the recurring units derived from these is higher than 40 wt %, the storage stability of the composition may be impaired. Therefore, the total content is preferably not higher than this value.

In the copolymer (A3), examples of the unsaturated compound (a2-5) are the same as compounds listed for the above unsaturated compound (a2-2).

Out of these unsaturated compounds (a2-5), methyl methacrylate, t-butyl methacrylate, cyclohexyl acrylate, tricyclo[5.2.1.0^{2,6}]decan-8-yl methacrylate, 2-methylcyclohexyl acrylate, N-phenylmaleimide, N-cyclohexylmaleimide, styrene, p-methoxystyrene and 1,3-buatdiene are preferred. These preferred unsaturated compounds (a2-5) have high copolymerization reactivity and are effective in enhancing the heat resistance and surface hardness of the obtained protective film, except 1,3-butadiene.

The above unsaturated compounds (a2-5) may be used alone or in combination of two or more.

Preferred examples of the copolymer (A3) include a copolymer of methyl glycidyl acrylate and styrene, copolymer of methyl glycidyl methacrylate and styrene, copolymer of methyl glycidyl acrylate and tricyclo[5.2.1.0^{2,6}] decan-8-yl methacrylate, copolymer of methyl glycidyl methacrylate and tricyclo[5.2.1.0^{2,6}]decan-8-yl methacrylate, copolymer of methyl glycidyl methacrylate, tricyclo[5.2.1.0^{2,6}]decan-8-yl methacrylate and styrene, copolymer of methyl glycidyl methacrylate, N-phenylmaleimide and styrene, copolymer of methyl glycidyl methacrylate, N-cyclohexylmaleimide and styrene, and copolymer of 6,7-epoxyheptyl methacrylate and dicyclopentanyl methacrylate.

Out of these copolymers (A3), more preferred are a copolymer of methyl glycidyl methacrylate and styrene, copolymer of methyl glycidyl methacrylate and tricyclo[5.2.1.0^{2,6}]decan-8-yl methacrylate, copolymer of methyl glycidyl methacrylate, tricyclo[5.2.1.0^{2,6}]decan-8-yl methacrylate and styrene, and copolymer of methyl glycidyl methacrylate, N-cyclohexylmaleimide and styrene.

In the copolymer (A3), the content of the recurring unit derived from the unsaturated compound (a1) is preferably 1 to 90 wt %, particularly preferably 40 to 90 wt % based on the total of all the recurring units.

When the content of the recurring unit derived from the unsaturated compound (a1) is lower than 1 wt %, the heat resistance and surface hardness of the protective film may lower and when the content is higher than 90 wt %, the storage stability of the composition may degrade.

The above (co)polymer [A] used in the present invention can be synthesized by radically polymerizing a monomer containing the above compound (a1) and the compound (a2) preferably in a solvent in the presence of a polymerization initiator.

The solvent used in the manufacture of the (co)polymer [A] is selected from alcohols, ethers, glycol ethers, ethylene glycol alkyl ether acetates, diethylene glycol, propylene glycol monoalkyl ether, propylene glycol alkylether acetates, aromatic hydrocarbons, ketones and esters.

Specific examples of these solvents include methanol and ethanol as the alcohols; tetrahydrofuran as the ethers; ethylene glycol monomethyl ether and ethylene glycol monoethyl ether as the glycol ethers; methyl cellosolve acetate and ethyl cellosolve acetate as the ethylene glycol alkyl ether acetates; diethylene glycol monomethyl ether, diethylene glycol monoethyl ether, diethylene glycol dimethyl ether, diethylene glycol diethyl ether and diethylene glycol ethyl methyl ether as the diethylene glycols; propylene glycol monomethyl ether, propylene glycol monoethyl ether, propylene glycol monopropyl ether and propylene glycol monobutyl ether as the propylene glycol monoalkyl ethers; propylene glycol methyl ether acetate, propylene glycol ethyl ether acetate, propylene glycol propyl ether acetate and propylene glycol butyl ether acetate as the propylene glycol alkyl ether acetates; propylene glycol methyl ether propionate, propylene glycol ethyl ether propionate, propylene glycol propyl ether propionate and propylene glycol butyl ether propionate as the propylene glycol alkyl ether acetates; toluene and xylene as the aromatic hydrocarbons; methyl ethyl ketone, cyclohexanone and 4-hydroxy-4-methyl-2-pentanone as the ketones; and methyl acetate, ethyl acetate, propyl acetate, butyl acetate, ethyl 2-hydroxypropionate, methyl 2-hydroxy-2-methylpropionate, ethyl 2-hydroxy-2-methylpropionate, methyl hydroxyacetate, ethyl hydroxyacetate, butyl hydroxyacetate, methyl lactate, ethyl lactate, propyl lactate, butyl lactate, methyl 3-hydroxypropionate, ethyl 3-hydroxypropionate, propyl 3-hydroxypropionate, butyl 3-hydroxypropionate, methyl 2-hydroxy-3-methylbutanoate, methyl methoxyacetate, ethyl methoxyacetate, propyl methoxyacetate, butyl methoxyacetate, methyl ethoxyacetate, ethyl ethoxyacetate, propyl ethoxyacetate, butyl ethoxyacetate, methyl propoxyacetate, ethyl propoxyacetate, propyl propoxyacetate, butyl propoxyacetate, methyl butoxyacetate, ethyl butoxyacetate, propyl butoxyacetate, butyl butoxyacetate, methyl 2-methoxypropionate, ethyl 2-methoxypropionate, propyl 2-methoxypropionate, butyl 2-methoxypropionate, methyl 2-ethoxypropionate, ethyl 2-ethoxypropionate, propyl 2-ethoxypropionate, butyl 2-ethoxypropionate, methyl 2-butoxypropionate, ethyl 2-butoxypropionate, propyl 2-butoxypropionate, butyl 2-butoxypropionate, methyl 3-methoxypropionate, ethyl 3-methoxypropionate, propyl 3-methoxypropionate, butyl 3-methoxypropionate, methyl 3-ethoxypropionate, ethyl 3-ethoxypropionate, propyl 3-ethoxypropionate, butyl 3-ethoxypropionate, methyl 3-propoxypropionate, ethyl 3-propoxypropionate, propyl 3-propoxypropionate, butyl 3-propoxypropionate, methyl 3-butoxypropionate, ethyl 3-butoxypropionate, propyl 3-butoxypropionate and butyl 3-butoxypropionate as the esters.

Out of these, ethylene glycol alkyl ether acetates, diethylene glycols, propylene glycol monoalkyl ethers and propylene glycol alkyl ether acetates are preferred, and diethylene glycol dimethyl ether, diethylene glycol ethyl methyl ether, propylene glycol methyl ether and propylene glycol methyl ether acetate are particularly preferred.

The amount of the above solvent is preferably 100 to 300 parts by weight, more preferably 150 to 280 parts by weight based on 100 parts by weight of the total of all the monomer components.

As the polymerization initiator used in the manufacture of the (co)polymer [A] may be used what is generally known as a radical polymerization initiator, as exemplified by azo compounds such as 2,2′-azobisisobutyronitrile, 2,2′-azobis-(2,4-dimethylvaleronitrile) and 2,2′-azobis-(4-methoxy-2,4-dimethylvaleronitrile); organic peroxides such as benzoyl peroxide, lauroyl peroxide, t-butylperoxypyvarate and 1,1-bis(t-butylperoxy)cyclohexane; and hydrogen peroxide. When a peroxide is used as the radical polymerization initiator, it may be used in combination with a reducing agent as a redox initiator.

The amount of the polymerization initiator is preferably 0.5 to 50 parts by weight, more preferably 1.5 to 40 parts by weight based on 100 parts by weight of the total of all the monomer components.

In the manufacture of the (co)polymer [A], a molecular weight control agent may be used to control the molecular weight. Examples of the molecular weight control agent include halogenated hydrocarbons such as chloroform and carbon tetrabromide; mercaptans such as n-hexylmercaptan, n-octylmercaptan, n-dodecylmercaptan, tert-dodecylmercaptan and thioglycolic acid; xanthogens such as dimethylxathogen sulfide and diisopropylxathogen disulfide; and terpinolene and α-methylstyrene dimer.

As for the radical polymerization conditions, the polymerization temperature is preferably 50 to 120° C., more preferably 60 to 110° C., and the polymerization time is preferably 1 to 9 hours, more preferably 3 to 7 hours.

The (co)polymer [A] used in the present invention has a weight average molecular weight in terms of polystyrene (to be referred to as “Mw” hereinafter) of preferably 2×10³ to 5×10⁵, more preferably 5×10³ to 1×10⁵. When Mw is lower than 2×10³, the heat resistance and surface hardness of the obtained film may become unsatisfactory and when Mw is higher than 5×10⁵, the flatness of the film surface may become unsatisfactory.

### [B] Ultraviolet Absorbent

The ultraviolet absorbent [B] can prevent halation which occurs from below when a colored resist or a microlens material formed above is patterned by adding the thermosetting resin composition of the present invention. That is, the ultraviolet absorbent is a compound which serves as an antihalation film, preferably a compound having a benzotriazole skeleton.

Examples of the above ultraviolet absorbent [B] include benzotriazole-based compounds such as 2-(5-methyl-2-hydroxyphenyl)benzotriazole, 2-[2-hydroxy-3,5-bis(α,α-dimethylbenzyl)phenyl]-2H-benzo triazole, 2-(3,5-di-t-butyl-2-hydroxyphenyl)benzotriazole, 2-(3-t-butyl-5-methyl-2-hydroxyphenyl)-5-chlorobenzotriazole, 2-(3,5-di-t-amyl-2-hydroxyphenyl)benzotriazole, 2-(2′-hydroxy-5′-t-octylphenyl)benzotriazole, methyl-3-[3-t-butyl-5-(2H-benzotriazol-2-yl)-4-hydroxyphenyl]propionate-polyethylene glycol and hydroxyphenylbenzotriazole derivatives, succinic acid dimethyl.1-(2-hydroxyethyl)-4-hydroxy-2,2,6,6-tetramethylpiperidine polycondensate, poly[{6-(1,1,3,3-tetramethylbutyl)amino-1,3,5-triazin-2,4-diyl}{(2,2,6,6-tetramethyl-4-piperidyl)imino} hexamethylene{(2,2,6,6-tetramethyl-4-piperidyl)imino}], N,N′-bis(3-aminopropyl)ethylenediamine.2,4-bis[N-butyl-N-(1,2,2,6,6-pentamethyl-4-piperidyl) amino]-6-chloro-1,3,5-triazine condensate, bis(2,2,6,6-tetramethyl-4-piperidyl)sebacate, bis(1,2,2,6,6-pentamethyl-4-piperidinyl)sebacate, 2-(3,5-d-t-butyl-4-hydroxybenzyl)-2-n-butyl malonic acid bis(1,2,2,6,6-pentamethyl-4-piperidyl, and 2,4-di-t-butylphenyl-3,5-di-t-butyl-4-hydroxybenzoate.

Out of these ultraviolet absorbents [B], 2-(3-t-butyl-5-methyl-2-hydroxyphenyl)-5-chlorobenzotriazole (commercially available product: TINUVIN326 [of Ciba Specialty Chemicals Co., Ltd.], 2-[2-hydroxy-3,5-bis(α,α-dimethylbenzyl)phenyl]-2H-benzo triazole [commercially available product: TINUVIN234 (of Ciba Specialty Chemicals Co., Ltd.)] and 2-hydroxy-benzoic acid phenyl ester are preferred, out of which TINUVIN326 and TINUVIN234 are particularly preferred.

The amount of the ultraviolet absorbent [B] is preferably 2 to 200 parts by weight, more preferably 5 to 100 parts by weight, most preferably 10 to 150 parts by weight based on 100 parts by weight of the polymer [A].

### <Other Components>

The thermosetting resin composition of the present invention comprises the above polymer [A] and the component [B] as essential components and may optionally comprise other components. The other components include, for example, [C] a curing agent, [D] a cationically polymerizable compound, [E] an adhesive aid, [F] a surfactant, and [G] an antioxidant/antiaging agent.

### [C] Curing Agent

A polycarboxylic acid or a polycarboxylic anhydride is preferably used as the curing agent [C] and serves to improve the hardness of an antihalation film in the composition of the present invention.

The above polycarboxylic acid is, for example, an aliphatic polycarboxylic acid, alicyclic polycarboxylic acid or aromatic polycarboxylic acid.

Specific examples of the polycarboxylic acid include succinic acid, glutaric acid, adipic acid, butanetetracarboxylic acid, maleic acid and itaconic acid as the aliphatic polycarboxylic acids; hexahydrophthalic acid, 1,2-cyclohexanedicarboxylic acid, 1,2,4-cyclohexanetricarboxylic acid and cyclopentanetetracarboxylic acid as the alicyclic polycarboxylic acids; and phthalic acid, isophthalic acid, terephthalic acid, trimellitic acid, pyromellitic acid and 1,2,5,8-naphthalenetetracarboxylic acid as the aromatic polycarboxylic acids.

Out of these, aromatic polycarboxylic acids are preferred from the viewpoint of the heat resistance of the formed film, and trimellitic acid is particularly preferred because a film having high heat resistance is obtained.

The above polycarboxylic anhydride is, for example, an aliphatic dicarboxylic anhydride, alicyclic polycarboxylic dianhydride, aromatic polycarboxylic anhydride, ester group-containing acid anhydride or a copolymer of an unsaturated polycarboxylic anhydride and an olefin-based unsaturated compound.

Specific examples of the polycarboxylic anhydride include itaconic anhydride, succinic anhydride, citraconic anhydride, dodecenylsuccinic anhydride, tricarbanilic anhydride, maleic anhydride, hexahydrophthalic anhydride, methyltetrahydrophthalic anhydride and himic anhydride as the aliphatic dicarboxylic anhydrides; 1,2,3,4-butanetetracarboxylic dianhydride and cyclopentanetetracarboxylic dianhydride as the alicyclic polycarboxylic dianhydrides; phthalic anhydride, pyromellitic anhydride, trimellitic anhydride and benzophenonetetracarboxylic anhydride as the aromatic polycarboxylic anhydrides; and ethylene glycol bis anhydrous trimellitate and glycerin tris anhydrous trimellitate as the ester group-containing acid anhydrides.

Out of these, aromatic polycarboxylic anhydrides are preferred, and trimellitic anhydride is particularly preferred because a film having high heat resistance is obtained.

The unsaturated polycarboxylic anhydride used to synthesize the above copolymer of an unsaturated polycarboxylic anhydride and an olefin-based unsaturated compound is, for example, an unsaturated polycarboxylic anhydride selected from the group consisting of itaconic anhydride, citraconic anhydride, maleic anhydride and cis-1,2,3,4-tetrahydrophthalic anhydride. These unsaturated polycarboxylic dianhydrides may be used alone or in combination of two or more.

The olefin-based unsaturated compound used to synthesize the above copolymer of an unsaturated polycarboxylic anhydride and an olefin-based unsaturated compound is, for example, an olefin-based unsaturated compound selected from the group consisting of styrene, p-methylstyrene, p-methoxystyrene, methyl methacrylate, t-butyl methacrylate, tricyclo[5.2.1.0^{2,6}]decan-8-yl methacrylate, 2-methylcyclohexyl acrylate, phenylmaleimide and cyclohexyl. The olefin-based unsaturated compounds may be used alone or in combination of two or more.

The amount of the constituent unit derived from the unsaturated polycarboxylic anhydride contained in the copolymer of an unsaturated polycarboxylic anhydride and an olefin-based unsaturated compound is preferably 1 to 80 wt %, more preferably 10 to 60 wt %.

The weight average molecular weight in terms of polystyrene of the copolymer of an unsaturated polycarboxylic anhydride and an olefin-based unsaturated compound is preferably 500 to 50,000, more preferably 500 to 10,000.

The unsaturated polycarboxylic anhydride and the olefin-based unsaturated compound may be synthesized by the same method as that of the above polymer [A].

The amount of the component [C] is preferably 3 to 30 parts by weight, more preferably 3 to 15 parts by weight based on 100 parts by weight of the polymer [A]. When the amount of the component [C] is smaller than 3 parts by weight, the resistance of the obtained film may become unsatisfactory. When the amount of the component [C] is larger than 30 parts by weight, the adhesion to the substrate of the obtained film may become unsatisfactory.

### [D] Cationically Polymerizable Compound

The cationically polymerizable compound [D] is a compound having two or more oxiranyl groups or oxetanyl groups in the molecule (except the above polymer [A]) and serves to improve the moist heat resistance of the composition of the present invention.

The compound having two or more oxiranyl groups or oxetanyl groups in the molecule is, for example, a compound having two or more epoxy groups or 3,4-epoxycyclohexyl groups in the molecule.

Examples of the compound having two or more epoxy groups in the molecule include diglycidyl ethers of a bisphenol compound such as bisphenol A diglycidyl ether, bisphenol F diglycidyl ether, bisphenol S diglycidyl ether, hydrogenated bisphenol A diglycidyl ether, hydrogenated bisphenol F diglycidyl ether, hydrogenated bisphenol AD diglycidyl ether, brominated bisphenol A diglycidyl ether, brominated bisphenol F diglycidyl ether and brominated bisphenol S diglycidyl ether; polyglycidyl ethers of a polyhydric alcohol such as 1,4-butanediol diglycidyl ether, 1,6-hexanediol diglycidyl ether, glycerin triglycidyl ether, trimethylolpropane triglycidyl ether, polyethylene glycol diglycidyl ether and polypropylene glycol diglycidyl ether; polyglycidyl ethers of a polyether polyol obtained by adding one or more alkylene oxides to an aliphatic polyhydric alcohol such as ethylene glycol, propylene glycol or glycerin; phenol novolak type epoxy resins; cresol novolak type epoxy resins; polyphenol type epoxy resins; diglycidyl esters of an aliphatic long-chain dibasic acid; glycidyl esters of a higher fatty acid; and epoxylated soybean oil and epoxylated linseed oil.

Commercially available products of the compound having two or more epoxy groups in the molecule include EPICOAT 1001, 1002, 1003, 1004, 1007, 1009, 1010 and 828 (of Japan Epoxy Resin Co., Ltd.) as the bisphenol A type epoxy resins; EPICOAT 807 (of Japan Epoxy Resin Co., Ltd.) as the bisphenol F type epoxy resins; EPICOAT 152, 154 and 157S65 (of Japan Epoxy Resin Co., Ltd.) and EPPN 201 and 202 (of Nippon Kayaku Co., Ltd.) as the phenol novolak type epoxy resins; EOCN102, 103A, 104S, 1020, 1025 and 1027 (of Nippon Kayaku Co., Ltd.) and EPICOAT 180S75 (of Japan Epoxy Resin Co., Ltd.) as the cresol novolak type epoxy resins; EPICOAT 1032H60 and XY-4000 (of Japan Epoxy Resin Co., Ltd.) as the polyphenol type epoxy resins; CY-175, 177 and 179, and Araldite CY-182, 192 and 184 (of Ciba Specialty Chemicals Holding Inc.), ERL-4234, 4299, 4221 and 4206 (of U.C.C Co., Ltd.), SHOWDYNE 509 (of Showa Denko K.K.), EPICLON 200 and 400 (of Dainippon Ink and Chemicals, Inc.), EPICOAT 871 and 872 (of Japan Epoxy Resin Co., Ltd.), and ED-5661 and 5662 (of Ceranies Coating Co., Ltd.) as the alicyclic epoxy resins; and EPOLITE 100MF (of Kyoeisha Chemical Co., Ltd.) and EPIOL TMP (of NOF Corporation) as the aliphatic polyglycidyl ethers.

Examples of the compound having two or more 3,4-epoxycyclohexyl groups in the molecule include 3,4-epoxycyclohexylmethyl-3′,4′-epoxycyclohexane carboxylate, 2-(3,4-epoxycyclohexyl-5,5-spiro-3,4-epoxy)cyclohexane-meta-dioxane, bis(3,4-epoxycyclohexylmethyl)adipate, bis(3,4-epoxy-6-methylcyclohexylmethyl)adipate, 3,4-epoxy-6-methylcyclohexyl-3′,4′-epoxy-6′-methylcyclohexane carboxylate, methylenebis(3,4-epoxycyclohexane), dicyclopentadiene diepoxide, di(3,4-epoxycyclohexylmethyl)ether of ethylene glycol, ethylenebis(3,4-epoxycyclohexane carboxylate) and lactone modified 3,4-epoxycyclohexylmethyl-3′,4′-epoxycyclohexane carboxylate.

Out of the above cationically polymerizable compounds [D], phenol novolak type epoxy resins and polyphenol type epoxy resins are preferred to improve heat resistance and dry etching resistance.

The amount of the cationically polymerizable compound [D] is preferably 3 to 200 parts by weight, more preferably 5 to 100 parts by weight, particularly preferably 10 to 50 parts by weight based on 100 parts by weight of the polymer [A]. When the amount of the cationically polymerizable compound [D] is larger than 200 parts by weight, there may arise a problem with the coatability of the composition. When the amount is smaller than 3 parts by weight, the hardness of the obtained film may become insufficient.

### [E] Adhesion Aid

The above adhesion aid [E] may be added to improve adhesion between the formed film and the substrate.

The adhesion aid [E] is preferably a functional silane coupling agent having a reactive substituent such as carboxyl group, methacryloyl group, isocyanate group or epoxy group. Specific examples of the adhesion aid [E] include trimethoxysilylbenzoic acid, γ-methacryloxypropyltrimethoxysilane, vinyl triacetoxysilane, vinyl trimethoxysilane, γ-isocyanatopropyltriethoxysilane, γ-glycidoxypropyltrimethoxysilane and β-(3,4-epoxycyclohexyl)ethyltrimethoxysilane.

The amount of the adhesion aid [E] is preferably 30 parts or less by weight, more preferably 0.1 to 25 parts by weight, particularly preferably 1 to 20 parts by weight based on 100 parts by weight of the polymer [A]. When the amount of the adhesion aid is larger than 30 parts by weight, the heat resistance of the obtained film may become unsatisfactory.

### [F] Surfactant

The above surfactant [F] may be added to improve the coatability of the composition.

The surfactant is, for example, a fluorine-based surfactant, silicone-based surfactant or nonionic surfactant.

Examples of the nonionic surfactant include polyoxyethylene alkyl ethers, polyoxyethylene aryl ethers and polyoxyethylene dialkyl esters.

Specific examples of the surfactant include polyoxyethylene lauryl ether, polyoxyethylene stearyl ether and polyoxyethylene oleyl ether as the polyoxyethylene alkyl ethers; polyoxyethylene octylphenyl ether and polyoxyethylene nonylphenol ether as the polyoxyethylene aryl ethers; and polyoxyethylene dilaurate and polyoxyethylene distearate as the polyoxyethylene dialkyl esters.

Commercially available products of the surfactant include BM-1000 and BM-1100 of BM CHIMIE Co., Ltd., MEGAFAC F142D, F172, F173 and F183 of Dainippon Ink and Chemicals, Inc., FLORADEFC-135, FC-170C, FC-430 and FC-431 of Sumitomo 3M Limited, SURFLONS-112, S-113, S-131, S-141, S-145, S-382, SC-101, SC-102, SC-103, SC-104, SC-105 and SC-106 of Asahi Glass Co., Ltd., and DFX-16, DFX-18 and DFX-20 of Neos Co., Ltd. as the fluorine-based surfactants; SH-28PA, SH-190, SH-193, SZ-6032, SF-8428, DC-57 and DC-190 of Toray Silicone Co., Ltd., KP341 of Shin-Etsu Chemical Co., Ltd., and F Top EF 301, EF303 and EF352 of JEMCO Inc. as the silicone-based surfactants; and (meth)acrylic acid-based copolymer POLYFLOW No. 57, No. 90 and No. 95 of Kyoeisha Chemical Co., Ltd. as the nonionic surfactants.

These surfactants may be used alone or in combination of two or more.

The amount of the surfactant [F] which differs according to its type and the types and amounts of the components constituting the thermosetting resin composition is preferably 5 parts or less by weight, more preferably 0.0001 to 2 parts by weight, much more preferably 0.001 to 0.5 part by weight based on 100 parts by weigh of the polymer [A].

### [G] Antioxidant/Antiaging Agent

The above antioxidant/antiaging agent [G] may be added to improve the heat resistance of the composition.

The antioxidant/antiaging agent is, for example, a hindered phenol.

Examples of the antioxidant/antiaging agent include triethylene glycol-bis[3-(3-t-butyl-5-methyl-4-hydroxyphenyl) propionate], 1,6-hexanediol-bis[3-(3,5-di-t-butyl-4-hydroxyphenyl) propionate], 2,4-bis-(n-octylthio)-6-(4-hydroxy-3,5-di-t-butylanilino)-1,3,5-triazine, pentaerythrityl-tetrakis[3-(3,5-di-t-butyl-4-hydroxyphenyl)propionate], 2,2-thio-diethylenebis[3-(3,5-di-t-butyl-4-hydroxyphenyl)propionate], octadecyl-3-(3,5-di-t-butyl-4-hydroxyphenyl)propionate, N,N′-hexamethylenebis(3,5-di-t-butyl-4-hydroxy-hydrocinnamide), 3,5-di-t-butyl-4-hydroxy-benzylphosphonate-diethyl ester, 1,3,5-trimethyl-2,4,6-tris(3,5-di-t-butyl-4-hydroxy benzyl)benzene, 2,4-bis[(octylthio)methyl]-O-cresol, isooctyl-3-(3,5-di-t-butyl-4-hydroxyphenyl)propionate and tris-(3,5-di-t-butyl-4-hydroxybenzyl)-isocyanurate.

The amount of the component [G] is preferably 0.01 to 50 parts by weight, more preferably 0.05 to 30 parts by weight, much more preferably 0.1 to 10 parts by weight based on 100 parts by weight of the polymer [A].

### Preparation of Thermosetting Resin Composition

The thermosetting resin composition of the present invention is dissolved in a suitable solvent before use. For example, the thermosetting resin composition in a solution state can be prepared by mixing together the polymer [A] and the component [B] and other components which are optionally added, in a predetermined ratio.

The thermosetting resin composition of the present invention is preferably prepared by uniformly dissolving or dispersing the above components in a suitable solvent. The solvent used is a solvent which dissolves or disperses the components of the composition and does not react with these components.

Examples of the solvent are the same as those listed for the solvent used to manufacture the above polymer [A].

The amount of the solvent is in a range that ensures that the total solids content (total amount of the polymer [A] and the component [B] and other components which are optionally added) of the thermosetting resin composition of the present invention becomes preferably 1 to 50 wt %, more preferably 5 to 40 wt %.

A high-boiling point solvent may be used in combination with the above solvent. Examples of the high-boiling point solvent include N-methylformamide, N,N-dimethylformamide, N-methylformanilide, N-methylacetamide, N,N-dimethylacetamide, N-methylpyrrolidone, dimethyl sulfoxide, benzyl ethyl ether, dihexyl ether, acetonylacetone, isophorone, caproic acid, caprylic acid, 1-octanol, 1-nonanol, benzyl alcohol, benzyl acetate, ethyl benzoate, diethyl oxalate, diethyl maleate, γ-butyrolactone, ethylene carbonate, propylene carbonate and phenyl cellosolve acetate.

The amount of the high-boiling point solvent is preferably 90 wt % or less, more preferably 80 wt % or less based on the total of all the solvents.

The solution of the thermosetting resin composition prepared as described above is filtered by a Millipore filter having an opening size of preferably 0.2 to 3.0 μm, more preferably 0.2 to 0.5 μm before use.

### Method of Forming the Antihalation Film of a Solid-State Imaging Device

A description is subsequently given of the method of forming the antihalation film of the solid-state imaging device of the present invention from the thermosetting resin composition of the present invention.

The method of forming the antihalation film of the solid-state imaging device of the present invention comprises at least the following steps:

[1] forming a coating film of the above thermosetting resin composition on a substrate; and
[2] heating the coating film.

Each step will be described hereinunder.

### [1] Step of Forming a Coating Film of the Above Thermosetting Resin Composition on a Substrate

In the method of forming the antihalation film of the solid-state imaging device of the present invention, the step of forming a coating film of the thermosetting resin composition of the present invention on the substrate is first carried out. The coating film is formed on the substrate by applying the thermosetting resin composition of the present invention.

In the present invention, as the substrate may be used a glass, quartz, silicon or resin substrate. Examples of the resin include polyethylene terephthalate, polybutylene terephthalate, polyether sulfone, polycarbonates, polyimides, ring opening polymers of a cyclic olefin, and hydrogenated products thereof.

A suitable coating technique such as spray coating, roll coating, rotational coating, bar coating or ink jet coating may be employed.

Thereafter, the coating film can be formed on the substrate by removing the solvent.

In the present invention, it is not necessary to provide the step of removing the solvent independently. The solvent may be naturally scattered during the process or the solvent removing step may be carried out in the subsequent step [2] of heating the coating film. The introduction of the separate solvent removing step is not forbidden. When the solvent removing step is carried out separately, it can be carried out by keeping the substrate at room temperature to about 150° C. for a suitable time.

The thickness of the coating film is preferably 0.1 to 5 μm, more preferably 0.5 to 3 μm. This value should be understood as the thickness of the film after the removal of the solvent.

[2] Step of Heating the Coating Film

The coating film formed on the substrate as described above is heated to obtain an antihalation film for the solid-state imaging device of the present invention.

The heating temperature is preferably 150 to 220° C. The heating time may be suitably set according to the type of a heater in use. When a hot plate is used as the heater, the coating film is heated for about 3 to 15 minutes and when a clean oven is used as the heater, the coating film is heated for about 15 to 30 minutes.

This heating step may be carried out once or two or more times.

### Antihalation Film for Solid-State Imaging Devices

The antihalation film for the solid-state imaging device of the present invention formed as described above can effectively suppress diffused reflection light from the foundation substrate in an exposure step for forming a color filter or microlens on the antihalation film and has high heat resistance.

Therefore, the color filter or microlens formed on the antihalation film of the solid-state imaging device of the present invention may have a desired shape and size.

The thickness of the antihalation film of the solid-state imaging device is preferably 0.1 to 5 μm, more preferably 0.5 to 3 μm.

When this value is smaller than 0.1 μm, the effect of suppressing diffused reflection light from the foundation substrate may become unsatisfactory. It is not necessary to increase the thickness to more than 5 μm.

### Solid-State Imaging Device

The solid-state imaging device of the present invention has the above antihalation film.

Since the color filter or microlens formed on the above antihalation film has a desired shape and size, the solid-state imaging device of the present invention has excellent reliability.

As described above, according to the present invention, there are provided a thermosetting resin composition having excellent storage stability and suitable for forming an antihalation film which can effectively suppress diffused reflection light from the foundation substrate in the exposure step for forming a color filter or microlens in a solid-state imaging device and which has high visible light transmittance and high heat resistance, a method of forming an antihalation film from the same, an antihalation film formed by the above method, and a solid-state imaging device having the antihalation film.

The antihalation film of the present invention can effectively suppress diffused reflection light from the foundation substrate in the exposure step for forming a color filter or microlens on the antihalation film and has high heat resistance. Therefore, the color filter or microlens formed on the antihalation film of the solid-state imaging device of the present invention can have a desired shape and size.

Further, since the solid-state imaging device of the present invention has the above antihalation film and the color filter or microlens formed on the antihalation film has a desired shape and size, the solid-state imaging device of the present invention has excellent reliability.

### EXAMPLES

The following synthesis examples and examples are provided for the purpose of further illustrating the present invention but are in no way to be taken as limiting.

### Synthesis Example 1

6 parts by weight of 2,2′-azobis(isobutyronitrile) and 200 parts by weight of propylene glycol monomethyl ether acetate were fed to a flask equipped with a cooling tube and a stirrer. Subsequently, 18 parts by weight of styrene (ST) and 82 parts by weight of methyl glycidyl methacrylate (M-GMA) were fed to the flask, the inside of the flask was substituted by nitrogen, and agitation was started gently. The temperature of the solution was raised to 95° C. and maintained at that temperature for 3 hours to obtain a polymer solution containing a copolymer [A-1]. The solids content of the obtained polymer solution was 33.7 wt %. The weight average molecular weight in terms of polystyrene of the polymer [A-1] was 8,600.

The weight average molecular weight in terms of polystyrene was measured by gel permeation chromatography (GPC). The same shall apply hereinunder.

### Synthesis Example 2

1 part by weight of 2,2′-azobis(isobutyronitrile) and 200 parts by weight of propylene glycol monomethyl ether acetate were fed to a flask equipped with a cooling tube and a stirrer. Subsequently, 35 parts by weight of styrene, 35 parts by weight of tricyclo[5.2.1.0^{2,6}]decan-8-yl methacrylate (DCM) and 30 parts by weight of methyl glycidyl methacrylate were fed to the flask, the inside of the flask was substituted by nitrogen, and agitation was started gently. The temperature of the solution was raised to 95° C. and maintained at that temperature for 3 hours to obtain a polymer solution containing a copolymer [A-2]. The solids content of the obtained polymer solution was 32.8 wt %, and the weight average molecular weight in terms of polystyrene of the polymer [A-2] was 20,000.

### Synthesis Example 3

7 parts by weight of 2,2′-azobis(2,4-dimethylvaleronitrile), 2 parts by weight of α-methylstyrene dimer and 200 parts by weight of propylene glycol monomethyl ether acetate were fed to a flask equipped with a cooling tube and a stirrer. Subsequently, 19 parts by weight of styrene, 38 parts by weight of tricyclo[5.2.1.0^{2,6}]decan-8-yl methacrylate (DCM), 13 parts by weight of methacrylic acid (MA) and 30 parts by weight of methyl glycidyl methacrylate were fed to the flask, the inside of the flask was substituted by nitrogen, and agitation was started gently. The temperature of the solution was raised to 95° C. and maintained at that temperature for 3 hours to obtain a polymer solution containing a copolymer [A-3]. The solids content of the obtained polymer solution was 32.9 wt %, and the weight average molecular weight in terms of polystyrene of the polymer [A-3] was 6,000.

### Synthesis Example 4

6 parts by weight of 2,2′-azobis(isobutyronitrile) and 200 parts by weight of propylene glycol monomethyl ether acetate were fed to a flask equipped with a cooling tube and a stirrer. Subsequently, 34 parts by weight of styrene, 16 parts by weight of cyclohexylmaleimide (CHMI), 10 parts by weight of methacrylic acid (MA) and 40 parts by weight of methyl glycidyl methacrylate were fed to the flask, the inside of the flask was substituted by nitrogen, and agitation was started gently. The temperature of the solution was raised to 95° C. and maintained at that temperature for 3 hours to obtain a polymer solution containing a copolymer [A-4]. The solids content of the obtained polymer solution was 32.8 wt %, and the weight average molecular weight in terms of polystyrene of the polymer [A-4] was 8,000.

### Comparative Synthesis Example 1

6 parts by weight of 2,2′-azobis(isobutyronitrile) and 200 parts by weight of propylene glycol monomethyl ether acetate were fed to a flask equipped with a cooling tube and a stirrer. Subsequently, 18 parts by weight of styrene (ST) and 82 parts by weight of glycidyl methacrylate (GMA) were fed to the flask, the inside of the flask was substituted by nitrogen, and agitation was started gently. The temperature of the solution was raised to 95° C. and maintained at that temperature for 3 hours to obtain a polymer solution containing a copolymer [a-1]. The solids content of the obtained polymer solution was 33.8 wt %, and the weight average molecular weight in terms of polystyrene of the polymer [a-1] was 8,600.

### Comparative Synthesis Example 2

1 part by weight of 2,2′-azobis(isobutyronitrile) and 200 parts by weight of diethylene glycol methyl ethyl ether were fed to a flask equipped with a cooling tube and a stirrer. Subsequently, 35 parts by weight of styrene, 15 parts by weight of tricyclo[5.2.1.0^{2,6}] decan-8-yl methacrylate (DCM), 10 parts by weight of methacrylic acid (MA) and 40 parts by weight of glycidyl methacrylate (GMA) were fed to the flask, the inside of the flask was substituted by nitrogen, and agitation was started gently. The temperature of the solution was raised to 95° C. and maintained at that temperature for 3 hours to obtain a polymer solution containing a copolymer [a-2]. The solids content of the obtained polymer solution was 32.9 wt %, and the weight average molecular weight in terms of polystyrene of the polymer [a-2] was 20,000.

### Example 1

30 parts by weight of TINUVIN 234 (of Chiba Specialty Chemicals Co., Ltd.) as the component [B] and 0.05 part by weight of SH28PA (silicone-based surfactant, manufactured by Toray Silicone Co., Ltd.) as a surfactant were added to 100 parts by weight (solid content) of the copolymer [A-1] of the above polymer solution containing the copolymer [A-1] obtained in Synthesis Example 1, and propylene glycol monomethyl ether acetate [S-1] was added as a solvent to ensure that the solids content of the obtained solution became 20 wt %.

### Formation of Antihalation Film

The thermosetting resin composition prepared as described above was applied to a glass substrate with a spin coater and heated on a hot plate at 180° C. for 3 minutes to form an antihalation film having a thickness of 1.62 μm.

### Evaluation of Antihalation Film

### (1) Light Transmittance

The transmittance at 365 nm and 400 nm of the substrate having the antihalation film formed as described above was measured with the 150-20 double-beam spectrophotometer (of Hitachi, Ltd.). After 20 minutes of the additional heating of the substrate on a hot plate at 185° C., its transmittance at 365 nm and 400 nm was measured likewise. These values are shown in Table 1. When the transmittance at 365 nm of the antihalation film is less than 95%, it can be said that antihalation capability, that is, the effect of suppressing diffused reflection light from the foundation substrate in the exposure step for forming a color filter or microlens is excellent. When the transmittance at 400 nm is 95% or more, it can be said that the antihalation film has excellent visible light transmittance.

As for the antihalation film formed in Example 1, it is understood that it is excellent in antihalation capability and visible light transmittance before and after additional heating.

### (2) Moist Heat Resistance

A change in the film thickness of the substrate having the antihalation film formed as described above was measured before and after it was treated at 85° C.-85% RH in a thermo-hygrostat for 7 days. The moist heat resistance calculated based on the following equation is shown in Table 1.

Moist heat resistance=[(film thickness after treatment−film thickness before treatment)/(film thickness before treatment)]×100(%)

### (3) Patterning of Microlens Material

A microlens material (MFR-380 of JSR Corporation) was applied to the substrate having the antihalation film formed as described above with a spinner and prebaked on a hot plate at 100° C. for 90 seconds to form a coating film having a thickness of 2.5 μm. The obtained coating film was exposed to 2,200 J/m² of light with the NSR1755i7A reduced projection exposure apparatus (NA=0.50., λ=365 nm) of Nikon Corporation through a pattern mask having 4.0 μm dots and 2.0 μm spaces and developed at 23° C. for 1 minute by a swing immersion method using an aqueous solution containing 1 wt % of tetramethylammonium hydroxide. Then, the developed film was rinsed in running super pure water at 23° C. for 30 seconds and dried to form a pattern on the antihalation film formed on the substrate.

The microlens pattern formed as described above was observed through a scanning electron microscope (S-4200 of Hitachi Keisokuki Service Co., Ltd.). The shape of the pattern is shown in Table 1.

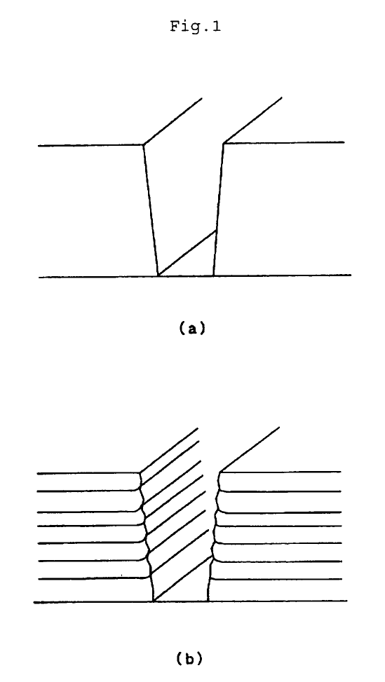

When the antihalation capability (the ability of suppressing diffused reflection light from the foundation substrate) of the antihalation film is satisfactory, the side faces of the pattern become flat as shown in FIG. 1(a). However, when the antihalation capability is not satisfactory, the side faces of the pattern become wavy as shown in FIG. 1(b) due to the influence of standing waves generated by halation at the time of exposure.

After 20 minutes of the additional heating of the substrate having the antihalation film formed as described above on a hot plate at 185° C., a microlens pattern was formed on the heated antihalation film in the same manner as described above. The observation result of the pattern shape through an electron microscope is shown in Table 1.

### (4) Measurement of Surface Hardness

The surface hardness of a protective film for the substrate having the antihalation film formed as described above was measured by a pencil scratch test in accordance with 8.4.1 of JIS K-5400-1990. This value is shown in Table 1. This hardness value must be HB or more, preferably H or more.

### (5) Evaluation of Storage Stability

The viscosity of the resin composition for forming a protective film prepared in Example 1 was measured with the ELD viscometer of Tokyo Keiki Co., Ltd. Thereafter, the solution viscosity of the composition at 25° C. was measured every day while the composition was left at 25° C. The number of days elapsed until the viscosity was increased by 5% from the value right after preparation was obtained and shown in Table 1. When the number of days is 20 or more, it can be said that storage stability is excellent.

### Examples 2 to 26 and Comparative Examples 1 to 3

Compositions were prepared and evaluated in the same manner as in Example 1 except that components shown in Tables 1 and 2 were used. The evaluation results are shown in Tables 1 and 2.

Additives in the tables are shown below.

### B-1: TINUVIN 326 (of Ciba Specialty Chemicals Co., Ltd.)

### B-2: TINUVIN 234 (of Ciba Specialty Chemicals Co., Ltd.)

B-3: 2-hydroxy-benzoic acid phenyl ester
C-1: trimellitic anhydride
D-1: bisphenol A novolak type epoxy resin, EPICOAT 828 (of Japan Epoxy Resin Co., Ltd.)
D-2: novolak type epoxy resin, EPICOAT 154 (of Japan Epoxy Resin Co., Ltd.)
E-1: γ-glycidoxypropyltrimethoxysilane

### F-1: SH-28PA (of Toray Dow Corning Silicone Co., Ltd.)

### G-1: Irganox 1035 (of Ciba Specialty Chemicals Co., Ltd.)

S-1: propylene glycol monomethyl ether acetate
S-2: propylene glycol monoethyl ether acetate
S-3: diethylene glycol methyl ethyl ether

TABLE 1

| | | | Examples | | | | | | | |
|---|---|---|---|---|---|---|---|---|---|---|
| | | | 1 | 2 | 3 | 4 | 5 | 6 | 7 | 8 |
| Copolymer | A-1 | ST/M-GMA | 100 | 100 | 100 | 100 | 100 | 100 | — | — |
| Component [A] | A-2 | ST/DCM/M-GMA | — | — | — | — | — | — | 100 | 100 |
| | A-3 | ST/DCM/MA/M-GMA | — | — | — | — | — | — | — | — |
| | A-4 | ST/CHMI/MA/M-GMA | — | — | — | — | — | — | — | — |
| | a-1 | ST/GMA | — | — | — | — | — | — | — | — |
| | a-2 | ST/DCM/MA/GMA | — | — | — | — | — | — | — | — |
| Component [B] | B-1 | TINUVIN326 | 30 | — | — | 6 | 30 | — | 30 | — |
| | B-2 | TINUVIN234 | — | 50 | 100 | — | — | — | — | 12 |
| | B-3 | 2-Hydroxy-benzoic acid phenyl | — | — | — | — | — | 3 | — | — |
| | | ester | | | | | | | | |
| Component [C] | C-1 | trimellitic anhydride | — | 5 | 5 | 3 | — | — | 10 | 3 |
| Component [D] | D-1 | bisphenol A novolak type epoxy | — | — | — | — | 10 | — | — | — |
| | | resin | | | | | | | | |
| | D-2 | novolak type epoxy resin | — | — | — | — | — | — | — | — |
| Component [E] | E-1 | γ-glycidoxypropyltrimethoxysilane | — | 5 | 5 | 5 | — | 5 | 5 | 5 |
| Component [F] | F-1 | silicone-based surfactant | 0.05 | 0.02 | 0.02 | 0.1 | 0.05 | 0.02 | 0.01 | 0.005 |
| | | (SH-28PA (of Toray Dow Corning | | | | | | | | |
| | | Silicone Co., Ltd.)) | | | | | | | | |
| Component [G] | G-1 | Irganox1035 | — | — | — | — | — | 0.05 | — | — |
| Solvent | | | S-1 = | S-1/S-2 = | S-1/S-2 = | S-1/S-2 = | S-1 = | S-1/S-2 = | S-1 = | S-1/S-2 = |
| | | | 100 | 50/50 | 50/50 | 80/20 | 100 | 70/30 | 100 | 50/50 |
| Solids content (%) | | | 20 | 20 | 20 | 20 | 20 | 20 | 20 | 20 |
| Thickness of antihalation film (μm) | | | 1.5 | 1.5 | 1.5 | 1.5 | 1.5 | 1.5 | 1.5 | 1.5 |
| Light | 365 nm | before | 40 | 33 | 20 | 87 | 45 | 89 | 40 | 62 |
| transmittance | | additional | | | | | | | | |
| (%) | | heating | | | | | | | | |
| | | after | 45 | 36 | 30 | 90 | 50 | 93 | 50 | 79 |
| | | additional | | | | | | | | |
| | | heating | | | | | | | | |
| | 400 nm | before | 99 | 99 | 99 | 99 | 99 | 99 | 99 | 99 |
| | | additional | | | | | | | | |
| | | heating | | | | | | | | |
| | | after | 99 | 99 | 99 | 99 | 99 | 99 | 99 | 99 |
| | | additional | | | | | | | | |
| | | heating | | | | | | | | |

| Moist heat resistance (%) | | 9 | 5 | 5 | 5 | 2 | 2 | 3 | 5 |
|---|---|---|---|---|---|---|---|---|---|
| Shape of microlens | before | (a) | (a) | (a) | (a) | (a) | (a) | (a) | (a) |
| pattern | additional | | | | | | | | |
| | heating | | | | | | | | |
| | after | (a) | (a) | (a) | (a) | (a) | (a) | (a) | (a) |
| | additional | | | | | | | | |
| | heating | | | | | | | | |

| | | | | | | | | |
|---|---|---|---|---|---|---|---|---|
| Pencil hardness | HB | H | F | 2H | HB | HB | 2H | H |
| Storage stability | 60 | 60 | 60 | 60 | 60 | 60 | 60 | 60 |
| (number of days) | | | | | | | | |

| | | | Examples | | | | | | |
|---|---|---|---|---|---|---|---|---|---|
| | | | 9 | 10 | 11 | 12 | 13 | 14 | 15 |
| Copolymer | A-1 | ST/M-GMA | — | — | — | — | — | — | — |
| Component | A-2 | ST/DCM/M-GMA | 100 | 100 | 100 | — | — | — | — |
| [A] | A-3 | ST/DCM/MA/M-GMA | — | — | — | 100 | 100 | 100 | 100 |
| | A-4 | ST/CHMI/MA/M-GMA | — | — | — | — | — | — | — |
| | a-1 | ST/GMA | — | — | — | — | — | — | — |
| | a-2 | ST/DCM/MA/GMA | — | — | — | — | — | — | — |
| Component | B-1 | TINUVIN326 | 1 | 6 | — | — | — | — | 12 |
| [B] | B-2 | TINUVIN234 | — | — | — | 50 | 30 | 18 | — |
| | B-3 | 2-Hydroxy-benzoic acid phenyl ester | — | — | 3 | — | — | — | — |
| Component | C-1 | trimellitic anhydride | — | — | — | — | — | — | — |
| [C] | | | | | | | | | |
| Component | D-1 | bisphenol A novolak type epoxy resin | — | — | — | — | — | — | — |
| [D] | D-2 | novolak type epoxy resin | — | — | — | — | — | 10 | — |
| Component | E-1 | γ-glycidoxypropyltrimethoxysilane | 5 | 5 | 5 | 5 | 5 | 5 | 5 |
| [E] | | | | | | | | | |
| Component | F-1 | silicone-based surfactant | 0.02 | 0.02 | 0.02 | 0.1 | 0.1 | 0.1 | 0.02 |
| [F] | | (SH-28PA (: trade name of Toray Dow | | | | | | | |
| | | Corning Silicone Co., Ltd.)) | | | | | | | |
| Component | G-1 | Irganox1035 | 0.05 | 0.05 | — | — | — | — | 0.05 |
| [G] | | | | | | | | | |
| Solvent | | | S-1/S-2 = | S-1/S-2 = | S-1/S-2 = | S-1/S-2 = | S-1/S-2 = | S-1/S-2 = | S-1/S-2 = |
| | | | 80/20 | 80/20 | 70/30 | 80/20 | 80/20 | 80/20 | 80/20 |
| Solids content (%) | | | 20 | 20 | 20 | 20 | 20 | 20 | 20 |
| Thickness of antihalation film (μm) | | | 1.5 | 1.5 | 1.5 | 1.5 | 1.5 | 1.5 | 1.5 |
| Light | 365 nm | before | 91 | 87 | 89 | 33 | 43 | 60 | 63 |
| transmittance | | additional | | | | | | | |
| (%) | | heating | | | | | | | |
| | | after | 94 | 90 | 93 | 36 | 50 | 73 | 78 |
| | | additional | | | | | | | |
| | | heating | | | | | | | |
| | 400 nm | before | 99 | 99 | 99 | 99 | 99 | 99 | 99 |
| | | additional | | | | | | | |
| | | heating | | | | | | | |
| | | after | 99 | 99 | 99 | 99 | 99 | 99 | 99 |
| | | additional | | | | | | | |
| | | heating | | | | | | | |

| Moist heat resistance (%) | | 9 | 9 | 9 | 3 | 2 | 2 | 2 |
|---|---|---|---|---|---|---|---|---|
| Shape of microlens | before | (a) | (a) | (a) | (a) | (a) | (a) | (a) |
| pattern | additional | | | | | | | |
| | heating | | | | | | | |
| | after | (a) | (a) | (a) | (a) | (a) | (a) | (a) |
| | additional | | | | | | | |
| | heating | | | | | | | |

| | | | | | | | |
|---|---|---|---|---|---|---|---|
| Pencil hardness | HB | HB | HB | H | 2H | 2H | 2H |
| Storage stability | 60 | 60 | 60 | 60 | 60 | 60 | 60 |
| (number of days) | | | | | | | |

TABLE 2

| | | | Examples | | | | | | |
|---|---|---|---|---|---|---|---|---|---|
| | | | 16 | 17 | 18 | 19 | 20 | 21 | 22 |
| Copolymer | A-1 | ST/M-GMA | — | — | — | — | — | — | — |
| Component [A] | A-2 | ST/DCM/M-GMA | — | — | — | — | — | — | — |
| | A-3 | ST/DCM/MA/M-GMA | 100 | 100 | — | — | — | — | — |
| | A-4 | ST/CHMI/MA/M-GMA | — | — | 100 | 100 | 100 | 100 | 100 |
| | a-1 | ST/GMA | — | — | — | — | — | — | — |
| | a-2 | ST/DCM/MA/GMA | — | — | — | — | — | — | — |
| Component [B] | B-1 | TINUVIN326 | — | — | — | — | — | 12 | — |
| | B-2 | TINUVIN234 | 6 | 3 | 100 | 30 | 50 | — | 8 |
| | B-3 | 2-Hydroxy-benzoic acid phenyl ester | — | — | — | — | — | — | — |
| Component [C] | C-1 | trimellitic anhydride | — | — | — | — | — | — | — |
| Component [D] | D-1 | bisphenol A novolak type epoxy resin | — | — | — | — | — | — | — |
| | D-2 | novolak type epoxy resin | — | — | — | — | — | — | — |
| Component [E] | E-1 | γ-glycidoxypropyltrimethoxysilane | 5 | 5 | — | 5 | 5 | 5 | — |
| Component [F] | F-1 | silicone-based surfactant (SH-28PA (: | 0.02 | 0.005 | 0.25 | 0.2 | 0.2 | 0.02 | 0.02 |
| | | trade name of Toray Dow Corning | | | | | | | |
| | | Silicone Co., Ltd.)) | | | | | | | |
| Component [G] | G-1 | Irganox1035 | 0.05 | — | — | — | — | 0.05 | — |
| Solvent | | | S-1/S-2 = | S-1 = | S-1/S-2 = | S-1/S-2 = | S-1/S-2 = | S-1/S-2 = | S-1/S-2 = |
| | | | 80/20 | 100 | 50/50 | 50/50 | 50/50 | 80/20 | 80/20 |
| Solids content (%) | | | 20 | 20 | 20 | 20 | 20 | 20 | 20 |
| Thickness of antihalation film (μm) | | | 1.5 | 1.5 | 1.5 | 1.5 | 1.5 | 1.5 | 1.5 |
| Light transmittance | 365 nm | before | 87 | 89 | 20 | 42 | 35 | 62 | 85 |
| (%) | | additional | | | | | | | |
| | | heating | | | | | | | |
| | | after | 90 | 93 | 33 | 50 | 36 | 77 | 89 |
| | | additional | | | | | | | |
| | | heating | | | | | | | |
| | 400 nm | before | 99 | 99 | 99 | 99 | 99 | 99 | 99 |
| | | additional | | | | | | | |
| | | heating | | | | | | | |
| | | after | 99 | 99 | 99 | 99 | 99 | 99 | 99 |
| | | additional | | | | | | | |
| | | heating | | | | | | | |

| Moist heat resistance (%) | | 2 | 2 | 9 | 2 | 5 | 2 | 2 |
|---|---|---|---|---|---|---|---|---|
| Shape of microlens pattern | before | (a) | (a) | (a) | (a) | (a) | (a) | (a) |
| | additional | | | | | | | |
| | heating | | | | | | | |
| | after | (a) | (a) | (a) | (a) | (a) | (a) | (a) |
| | additional | | | | | | | |
| | heating | | | | | | | |

| | | | | | | | |
|---|---|---|---|---|---|---|---|
| Pencil hardness | 2H | 2H | F | 2H | H | 2H | 2H |
| Storage stability | 60 | 60 | 60 | 60 | 60 | 60 | 60 |
| (number of days) | | | | | | | |

| | | | | | | | Comparative | | |
|---|---|---|---|---|---|---|---|---|---|
| | | | Examples | | | | Examples | | |
| | | | 23 | 24 | 25 | 26 | 1 | 2 | 3 |
| Copolymer | A-1 | ST/M-GMA | — | — | — | — | — | — | 100 |
| Component [A] | A-2 | ST/DCM/M-GMA | — | — | — | — | — | — | — |
| | A-3 | ST/DCM/MA/M-GMA | — | — | | — | — | — | — |
| | A-4 | ST/CHMI/MA/M-GMA | 100 | 100 | 100 | 100 | — | — | — |
| | a-1 | ST/GMA | — | — | — | — | 100 | — | — |
| | a-2 | ST/DCM/MA/GMA | — | — | — | — | — | 100 | — |
| Component [B] | B-1 | TINUVIN326 | — | 1 | — | 3 | 12 | 12 | — |
| | B-2 | TINUVIN234 | 12 | — | 6 | — | — | — | — |
| | B-3 | 2-Hydroxy-benzoic acid phenyl ester | — | — | — | — | — | — | — |
| Component [C] | C-1 | trimellitic anhydride | — | — | — | — | 10 | — | — |
| Component [D] | D-1 | bisphenol A novolak type epoxy resin | 10 | — | — | — | — | — | — |
| | D-2 | novolak type epoxy resin | — | — | — | — | — | — | — |
| Component [E] | E-1 | γ-glycidoxypropyltrimethoxysilane | — | 5 | 5 | 5 | 5 | 5 | 5 |
| Component [F] | F-1 | silicone-based surfactant | 0.02 | 0.005 | 0.25 | 0.005 | 0.01 | 0.02 | 0.005 |
| | | (SH-28PA (: trade name of Toray Dow | | | | | | | |
| | | Corning Silicone Co., Ltd.)) | | | | | | | |
| Component [G] | G-1 | Irganox1035 | — | — | — | — | — | — | — |
| Solvent | | | S-1/S-2 = | S-1 = | S-1/S-2 = | S-1 = | S-1/S-2 = | S-3/S-2 = | S-1/S-2 = |
| | | | 80/20 | 100 | 70/30 | 100 | 50/50 | 80/20 | 70/30 |
| Solids content (%) | | | 20 | 20 | 20 | 20 | 20 | 20 | 20 |
| Thickness of antihalation film (μm) | | | 1.5 | 1.5 | 1.5 | 1.5 | 1.5 | 1.5 | 1.5 |
| Light transmittance | 365 nm | before | 64 | 93 | 87 | 88 | 63 | 64 | 99 |
| (%) | | additional | | | | | | | |
| | | heating | | | | | | | |
| | | after | 79 | 94 | 90 | 92 | 77 | 79 | 99 |
| | | additional | | | | | | | |
| | | heating | | | | | | | |
| | 400 nm | before | 99 | 99 | 99 | 99 | 99 | 99 | 99 |
| | | additional | | | | | | | |
| | | heating | | | | | | | |
| | | after | 99 | 99 | 99 | 99 | 99 | 99 | 99 |
| | | additional | | | | | | | |
| | | heating | | | | | | | |

| Moist heat resistance (%) | | 2 | 2 | 2 | 2 | 5 | 3 | 15 |
|---|---|---|---|---|---|---|---|---|
| Shape of microlens pattern | before | (a) | (a) | (a) | (a) | (a) | (a) | (a) |
| | additional | | | | | | | |
| | heating | | | | | | | |
| | after | (a) | (a) | (a) | (a) | (a) | (a) | (b) |
| | additional | | | | | | | |
| | heating | | | | | | | |

| | | | | | | | |
|---|---|---|---|---|---|---|---|
| Pencil hardness | 2H | 2H | 2H | 2H | H | 2H | HB |
| Storage stability | 60 | 60 | 60 | 60 | 7 | 7 | 60 |
| (number of days) | | | | | | | |

As described above, the thermosetting resin composition of the present invention is suitable for forming an antihalation film which can effectively suppress diffused reflection light from the foundation substrate in the exposure step for forming a color filter or microlenses in a solid-state imaging device and which has high visible light transmittance and high heat resistance. Therefore, it is useful for an antihalation film and a solid-state imaging device having the antihalation film.

1. A thermosetting resin composition comprising [A] a polymer having a methylglycidyl group and [B] an ultraviolet absorbent.

2. The thermosetting resin composition according to claim 1, wherein the component [A] is a copolymer of (a1) a polymerizable unsaturated compound having a methylglycidyl group and (a2) a polymerizable unsaturated compound different from the above component (a1).

3. The thermosetting resin composition according to claim 2, wherein the polymerizable unsaturated compound (a2) of the component [A] comprises one or more polymerizable unsaturated compounds and at least one of them is a polymerizable unsaturated carboxylic acid and/or a polymerizable unsaturated polycarboxylic anhydride.

4. The thermosetting resin composition according to any one of claims 1 to 3, wherein the ultraviolet absorbent [B] has a benzotriazole skeleton.

5. The thermosetting resin composition according to any one of claims 1 to 4 which further comprises [C] a curing agent.

6. The thermosetting resin composition according to any one of claims 1 to 5 which further comprises [D] a cationically polymerizable compound.

7. The thermosetting resin composition according to any one of claims 1 to 6 which is used to form an antihalation film for solid-state imaging devices.

8. A method of forming an antihalation film for solid-state imaging devices, comprising at least the following steps [1] and [2]:
[1] forming a coating film of the thermosetting resin composition of claim 1 on a substrate; and
[2] heating the coating film.

9. An antihalation film for solid-state imaging devices, which is formed by the method of claim 8.

10. A solid-state imaging device having the antihalation film of claim 9.
